(19) United States
(12) Patent Application Publication
(10) Pub. No.: US 2017/0008765 A1
(43) Pub. Date: Jan. 12, 2017

(54) Method And Apparatus For Separation Of Offgas In The Combustion Of Particular Metals

(71) Applicant: SIEMENS AKTIENGESELLSCHAFT, München (DE)

(72) Inventors: Manfred Baldauf, Erlangen (DE); Walter Preidel, Erlangen (DE); Guenter Schmid, Hemhofen (DE); Dan Taroata, Erlangen (DE)

(73) Assignee: Siemens Aktiengesellschaft, Muenchen (DE)

(21) Appl. No.: 15/119,523

(22) PCT Filed: Feb. 11, 2015
(86) PCT No.: PCT/EP2015/052834

§ 371 Date: Aug. 17, 2016

(30) Foreign Application Priority Data
Feb. 19, 2014 (DE) 102014203039.0

(51) Int. Cl. C01B 21/06; F23B 80/00; F23J 15/02; C01D 15/08; F23C 3/00

(52) U.S. Cl. CPC C01B 21/061; C01D 15/08; F23C 3/006; F23J 15/027; F23B 80/00; F23J 2217/30; F23J 2217/40; F23B 2900/00003

(57) ABSTRACT

A method is provided for separating offgas from solid and/or liquid reaction products in the combustion of a metal M selected from alkali metals, alkaline earth metals, Al and Zn, and mixtures thereof, with a combustion gas. In a reaction step, the combustion gas is combusted with the metal M, forming offgas and further solid and/or liquid reaction products, and, in a separation step, the offgas is separated from the solid and/or liquid reaction products. In the separation step, a carrier gas is additionally added and the carrier gas is removed as a mixture with the offgas.

### CROSS-REFERENCE TO RELATED APPLICATIONS

This application is a U.S. National Stage Application of International Application No. PCT/EP2015/052834 filed Feb. 11, 2015, which designates the United States of America, and claims priority to DE Application No. 10 2014 203 039.0 filed Feb. 19, 2014, the contents of which are hereby incorporated by reference in their entirety.

### TECHNICAL FIELD

The present invention relates to a process for separating offgas from solid and/or liquid reaction products in the combustion of a metal M selected from among alkali metals, alkaline earth metals, Al and Zn and mixtures thereof by means of a combustion gas, wherein the combustion gas is burnt with the metal M in a reaction step and offgas and also further solid and/or liquid reaction products are formed, and the off gas is separated from the solid and/or liquid reaction products in a separation step, where a carrier gas is additionally added in the separation step and the carrier gas is discharged as a mixture with the offgas, and also an apparatus for carrying out the method.

### BACKGROUND

Over the years, many energy generation devices which operate using heat generated in the oxidation of metallic lithium have been proposed (e.g. U.S. Pat. No. 3,328,957). In such a system, water and lithium are reacted with one another to produce lithium hydroxide, hydrogen and steam. At another place in the system, the hydrogen produced by the reaction between lithium and water is combined with oxygen to form additional steam. The steam is then utilized for driving a turbine or the like, so that an energy generation source is obtained. Lithium can also additionally be used for obtaining basic materials. Examples are the reaction with nitrogen to form lithium nitride and subsequent hydrolysis to form ammonia or with carbon dioxide to form lithium oxide and carbon monoxide. The solid final end product of the reaction of the lithium is in each case, optionally after hydrolysis as in the case of nitride, the oxide or carbonate which can then be reduced again to lithium metal by means of electrolysis. This establishes a circuit in which excess electric power produced by wind power, photovoltaics or other renewable energy sources can be stored and converted back into electric power at the desired time or else basic chemical materials can be obtained.

Lithium is usually produced using melt flux electrolysis. Efficiencies of about 42-55%, calculated from process data without temperature correction of the standard potential, are obtained for this process. Apart from lithium, similar metals such as sodium, potassium, magnesium, calcium, aluminum and zinc can also be used.

Since solid or liquid residues can be formed in the combustion of lithium, depending on the temperature and combustion gas, particular attention is to be paid thereto. In addition, depending on the structure and operation of a furnace for the combustion of lithium metal (e.g. liquid) in various atmospheres and under superatmospheric pressure, offgases and solids/liquid materials can be formed as combustion products. These solid or liquid materials have to be separated off as completely as possible from the offgases.

A largely complete separation of the liquid and solid combustion residues from the offgas stream is important in order not to produce any surface deposits or blockages in the subsequent apparatuses. In particular, it is very demanding to feed the offgas stream directly to a gas turbine since it then has to be ensured that all particles have been completely removed from the offgas stream. Such particles damage the blades of the gas turbine in the long term and lead to failure of the plant.

### SUMMARY

One embodiment provides a process for separating offgas from solid and/or liquid reaction products in the combustion of a metal M selected from among alkali metals, alkaline earth metals, Al and Zn and mixtures thereof by means of a combustion gas, wherein the combustion gas is burnt with the metal M in a reaction step and offgas and also further solid and/or liquid reaction products are formed; and the offgas is separated from the solid and/or liquid reaction products in a separation step, where a carrier gas is additionally added in the separation step and the carrier gas is discharged as a mixture with the offgas.

In one embodiment, the mixture of offgas and carrier gas is at least partly fed as carrier gas back to the separation step and/or fed as combustion gas to the combustion step.

In one embodiment, the separation step is carried out in a cyclone reactor.

In one embodiment, the cyclone reactor additionally comprises a mesh through which the solid and/or liquid reaction products in the combustion of the metal M by means of the combustion gas can be discharged.

In one embodiment, the combustion gas comprises air, oxygen, carbon monoxide, carbon dioxide, sulfur dioxide, hydrogen, water vapor, nitrogen oxides NOₓ such as dinitrogen monoxide, nitrogen or mixtures of one or more thereof.

In one embodiment, the mixture of offgas and carrier gas is used for heating a boiler or for transferring heat in a heat exchanger.

In one embodiment, the mixture of the carrier gas and the offgas after the combustion is under elevated pressure.

In one embodiment, at least part of the offgas corresponds to the carrier gas.

Another embodiment provides an apparatus for the separation of offgas in the combustion of a metal M selected from among alkali metals, alkaline earth metals, Al and Zn and mixtures thereof by means of a combustion gas, which comprises: a burner for burning the metal M by means of the combustion gas, which is configured for burning the metal M by means of the combustion gas; a feed device for combustion gas which is configured for feeding combustion gas to the burner; a feed device for metal M which is configured for feeding metal M to the burner; a reactor which is connected to the burner; a feed device for carrier gas which is configured for feeding carrier gas to the reactor; a discharge device for a mixture of offgas and carrier gas, which is configured for discharging a mixture of the offgas of the combustion of metal M by means of the combustion gas and the carrier gas; and a discharge device for solid and/or liquid reaction products of the combustion of metal M by means of the combustion gas, which is configured for discharging solid and/or liquid reaction products of the combustion of metal M by means of the combustion gas.

In one embodiment, the discharge device for a mixture of offgas and carrier gas is connected to the feed device for carrier gas and/or the feed device for combustion gas in such a way that the mixture of offgas and carrier gas is fed at least partly to the reactor as carrier gas and/or to the burner as combustion gas.

In one embodiment, the reactor is a cyclone reactor.

In one embodiment, the cyclone reactor comprises a mesh which is configured in such a way that the solid and/or liquid reaction products in the combustion of the metal M by means of the combustion gas can be discharged through the mesh.

In one embodiment, the apparatus further comprises at least one boiler and/or at least one heat exchanger which is located in the reactor and/or the discharge device for the mixture of offgas and carrier gas.

In one embodiment, the apparatus further comprises an offtake device in the discharge device for the mixture of offgas and carrier gas, which offtake device is configured, in the case of recirculation of the mixture of offgas and carrier gas to the feed device for carrier gas and/or the feed device for combustion gas by connection of the discharge device for the mixture of offgas and carrier gas to the feed device for carrier gas and/or the feed device for combustion gas, for taking off part of the mixture of offgas and carrier gas.

### BRIEF DESCRIPTION OF THE DRAWINGS

Example aspects and embodiments of the invention are described in detail below with reference to the drawings, in which:

FIG. 1 schematically shows an illustrative arrangement for an apparatus according to the invention.

FIG. 2 schematically shows a detail view in a further illustrative arrangement for an apparatus according to the invention.

FIG. 3 schematically shows a further detail view in an additional illustrative arrangement for an apparatus according to the invention.

FIG. 4 schematically shows an illustrative cross section through an illustrative apparatus according to the invention in the region of the feed device for the carrier gas to the reactor.

FIG. 5 shows a scheme for an illustrative reaction of lithium and carbon dioxide to form lithium carbonate which can be carried out according to the process of the invention.

FIG. 6 shows a scheme for a further illustrative reaction of lithium and nitrogen to form lithium nitride and further downstream products, which can be carried out according to the process of the invention.

### DETAILED DESCRIPTION

Embodiments of the present invention provide a process and an apparatus by means of which efficient separation of solid and/or liquid reaction products from the offgas can be achieved in the combustion of a metal M selected from among alkali metals, alkaline earth metals, Al and Zn and mixtures thereof by means of a combustion gas.

It has now been discovered that efficient separation of offgas from solid and/or liquid reaction products of the above combustion can be achieved by introduction of a carrier gas in the separation step. Furthermore, it has been found that efficient removal of the heat evolved during the combustion can be achieved by the introduction of a carrier gas, so that this heat can be utilized efficiently for generating energy, for example electric energy via a gas turbine, and efficient removal of the heat from the reactor can be achieved, so that the material of the reactor, for example the reactor wall, is also protected and a correspondingly simpler reactor construction is possible.

Some embodiments provide a process for separating offgas from solid and/or liquid reaction products in the combustion of a metal M selected from among alkali metals, alkaline earth metals, Al and Zn and mixtures thereof by means of a combustion gas, wherein the combustion gas is burnt with the metal M in a reaction step and offgas and also further solid and/or liquid reaction products are formed; and the offgas is separated from the solid and/or liquid reaction products in a separation step, where a carrier gas is additionally added in the separation step and the carrier gas is discharged as a mixture with the offgas.

Other embodiments provide an apparatus for the separation of offgas in the combustion of a metal M selected from among alkali metals, alkaline earth metals, Al and Zn and mixtures thereof by means of a combustion gas, which comprises:
a burner for burning the metal M by means of the combustion gas, which is configured for burning the metal M by means of the combustion gas;
a feed device for combustion gas which is configured for feeding combustion gas to the burner;
a feed device for metal M which is configured for feeding metal M to the burner;
a reactor which is connected to the burner;
a feed device for carrier gas which is configured for feeding carrier gas to the reactor;
a discharge device for a mixture of offgas and carrier gas, which is configured for discharging a mixture of the offgas of the combustion of metal M by means of the combustion gas and the carrier gas; and
a discharge device for solid and/or liquid reaction products of the combustion of metal M by means of the combustion gas, which is configured for discharging solid and/or liquid reaction products of the combustion of metal M by means of the combustion gas.

Some embodiments of the present invention provide a process for separating offgas from solid and/or liquid reaction products in the combustion of a metal M selected from among alkali metals, alkaline earth metals, Al and Zn and mixtures thereof by means of a combustion gas, wherein the combustion gas is burnt with the metal M in a reaction step and offgas and also further solid and/or liquid reaction products are formed, and the offgas is separated from the solid and/or liquid reaction products in a separation step, where a carrier gas is additionally added in the separation step and the carrier gas is discharged as a mixture with the offgas. The carrier gas can here also correspond to the offgas, so that, for example, an offgas which corresponds to the carrier gas introduced or else corresponds to the combustion gas is formed in the combustion.

The metal M is, in particular embodiments, selected from among alkali metals, preferably Li, Na, K, Rb and Cs, alkaline earth metals, preferably Mg, Ca, Sr and Ba, Al and Zn, and mixtures thereof. In preferred embodiments, the metal M is selected from among Li, Na, K, Mg, Ca, Al and Zn, more preferably Li and Mg, and particular preference is given to the metal M being lithium.

As combustion gas, it is possible to employ, in particular embodiments, gases which can react with said metal or mixtures of the metals in an exothermic reaction, with these not being subject to any particular restrictions. For example, the combustion gas can comprise air, oxygen, carbon monoxide, carbon dioxide, hydrogen, water vapor, nitrogen oxides NOₓ such as dinitrogen monoxide, nitrogen, sulfur dioxide or mixtures thereof. The process can thus also be used for desulfurization or NOₓ removal. Depending on the combustion gas, various products can be obtained with the various metals and these can be obtained as solid, liquid or else in gaseous form.

Thus, for example in a reaction of metal M, for example lithium, with nitrogen, it is possible for, inter alia, metal nitride such as lithium nitride to be formed and this can then be left to react further to form ammonia later, while in a reaction of metal M, e.g. lithium, with carbon dioxide, it is possible for, for example, metal carbonate, e.g. lithium carbonate, carbon monoxide, metal oxide, e.g. lithium oxide, or metal carbide, e.g. lithium carbide, or mixtures thereof to be formed, with higher-value carbon-containing products such as methane, ethane, methanol, etc., being able to be obtained from the carbon monoxide, for example in a Fischer-Tropsch process, while acetylene, for example, can be obtained from metal carbide, e.g. lithium carbide. Furthermore, metal nitride, for example, can, for example, also be formed when using dinitrogen monoxide as combustion gas.

Analogous reactions can also occur for the other metals mentioned.

The carrier gas is not subject to any particular restrictions according to the invention and can correspond to the combustion gas, but can also be different therefrom. As carrier gas, it is possible to employ, for example, air, carbon monoxide, carbon dioxide, oxygen, methane, hydrogen, water vapor, nitrogen, dinitrogen monoxide, mixtures of two or more of these gases, etc. Here, various gases such as methane can serve for heat transport and remove the heat of reaction of the reaction of metal M with the combustion gas from the reactor. The various carrier gases can, for example, be matched suitably to the reaction of the combustion gas with the metal M in order here to achieve possible synergistic effects.

For a combustion of carbon dioxide with metal M, for example lithium, in which carbon monoxide can be formed, it is possible to use, for example, carbon monoxide as carrier gas and optionally circulate this, i.e. recirculate it at least partly as carrier gas after discharge. Here, the carrier gas is matched to the offgas so that part of the carrier gas can optionally be taken off as product of value, for example for a subsequent Fischer-Tropsch synthesis, while it is generated again by the combustion of carbon dioxide with metal M, so that overall carbon dioxide is at least partly converted into carbon monoxide, preferably to an extent of 90% by volume or more, more preferably 95% by volume or more, even more preferably 99% by volume or more and particularly preferably 10% by volume, based on the carbon dioxide used, and taken off as product of value. The more carbon monoxide that is produced, the cleaner is the carbon monoxide discharged.

In a combustion of nitrogen with metal M, for example lithium, it is possible for, for example, nitrogen to serve as carrier gas so that unreacted nitrogen from the combustion can be present as “offgas” in addition to the carrier gas nitrogen in the offgas, as a result of which a gas separation, if desired, can be carried out more simply and, in particular embodiments, can also be unnecessary in the combustion of metal M and nitrogen using suitable parameters which can easily be determined. Thus, for example, ammonia can easily be removed by scrubbing out or cooling.

In particular embodiments, at least part of the offgas can correspond to the carrier gas. For example, the offgas can correspond to an extent of at least 10% by volume, preferably 50% by volume or more, more preferably 60% by volume or more, even more preferably 70% by volume or more and even more preferably 80% by volume or more, based on the total volume of the offgas, to the carrier gas. In particular embodiments, the combustion gas can correspond to an extent of 90% by volume or more, based on the total volume of the offgas, to the carrier gas and in some cases can even correspond to an extent of 100% by volume to the carrier gas.

In particular embodiments, the mixture of offgas and carrier gas in the process of the invention can be fed at least partly back to the separation step as carrier gas and/or to the combustion step as combustion gas. Recirculation of the mixture of offgas and carrier gas can, for example, be carried out to an extent of 10% by volume or more, preferably 50% by volume or more, more preferably 60% by volume or more, even more preferably 70% by volume or more and even more preferably 80% by volume or more, based on the total volume of the carrier gas and offgas. In particular embodiments, recirculation of the mixture of offgas and carrier gas can be carried out to an extent of 90% by volume or more, based on the total volume of the carrier gas and offgas. In some embodiments, a reaction between combustion gas and metal M can occur in such a way that the carrier gas is formed as offgas, e.g. when using carbon dioxide as combustion gas and carbon monoxide as carrier gas, so that the mixture of carrier gas and offgas then consists essentially, preferably to an extent of 90% by volume and more, more preferably 95% by volume and more, even more preferably 99% by volume and more and particularly preferably 100% by volume, based on the mixture of offgas and carrier gas, of the carrier gas. Here, the carrier gas can then be circulated continuously and be taken off in an amount in which it is reproduced by the combustion of metal M and combustion gas. Compared to pure circulation of the carrier gas, in which a separation of carrier gas and offgas may occur, it is here possible to obtain, for example, a product of value which can be taken off continuously.

In particular embodiments, the separation step is carried out in a cyclone reactor in a process according to the invention. The cyclone reactor is not subject to any particular restrictions in terms of its structure and can, for example, have a shape like normal cyclone reactors.

For example, a cyclone reactor can comprise a reaction region on which the feed devices for the combustion gas, metal M and the carrier gas (which can also optionally be combined beforehand and then fed together to the reaction region) can be installed, for example in the form of a rotationally symmetric upper part, a separation region which has, for example, a conical configuration, and a depressurization chamber on which a discharge device for solid and/or liquid reaction products of the combustion of metal M by means of the combustion gas, for example in the form of a star feeder, and also a discharge device for the mixture of offgas and carrier gas which is obtained after mixing of the two gases after combustion of the metal M in the combustion gas can be installed.

Such apparatus components are, for example, usually present in cyclone separators. A cyclone reactor used according to the invention can, however, also have a different structure and optionally also comprise further regions. For example, individual regions (e.g. reaction region, separation region, depressurization chamber) can also be combined in one component of an illustrative cyclone reactor and/or extend over a plurality of components of a cyclone reactor.

In particular embodiments, the cyclone reactor additionally comprises a mesh through which the solid and/or liquid reaction products in the combustion of the metal M by means of the combustion gas can be discharged.

The mixture of offgas and carrier gas can, in particular embodiments, be used, for example in the reactor and/or during and/or after discharge from the reactor, for heating a boiler or for heat transfer in a heat exchanger or a turbine, for example a gas turbine.

Furthermore, the mixture of the carrier gas and the offgas can, in particular embodiments, be under superatmospheric pressure after the combustion.

Other embodiments of the invention provide an apparatus for the separation of offgas in the combustion of a metal M selected from among alkali metals, alkaline earth metals, Al and Zn by means of a combustion gas, which comprises:
a burner for burning the metal M by means of the combustion gas, which is configured for burning the metal M by means of the combustion gas;
a feed device for combustion gas which is configured for feeding combustion gas to the burner;
a feed device for metal M which is configured for feeding metal M to the burner;
a reactor which is connected to the burner;
a feed device for carrier gas which is configured for feeding carrier gas to the reactor;
a discharge device for a mixture of offgas and carrier gas, which is configured for discharging a mixture of the offgas of the combustion of metal M by means of the combustion gas and the carrier gas; and
a discharge device for solid and/or liquid reaction products of the combustion of metal M by means of the combustion gas, which is configured for discharging solid and/or liquid reaction products of the combustion of metal M by means of the combustion gas.

The burner is not subject to any particular restrictions according to the invention and can, for example, be configured as a nozzle in which the combustion gas is mixed with the metal M and then optionally ignited by means of an ignition device. The burner can also be provided in or on the reactor.

The feed devices are also not subject to any particular restrictions and comprise, for example, tubes, hoses, conveyor belts, etc., which can appropriately be determined from the state of matter of the metal or the state of the gas, which can optionally also be under superatmospheric pressure.

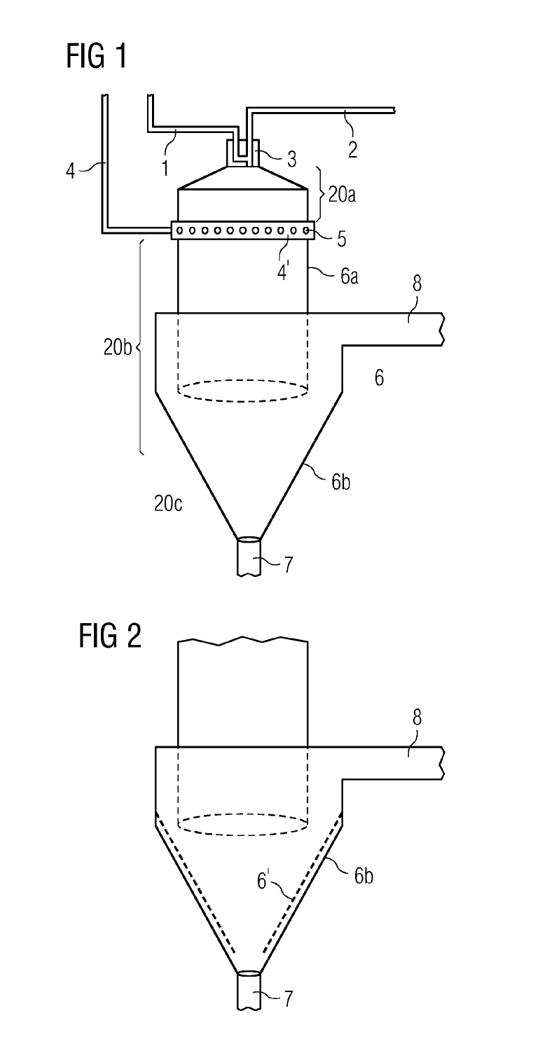

The reactor is likewise not subject to any particular restrictions as long as the combustion of the combustion gas with the metal M can proceed therein. In particular embodiments, the reactor can be a cyclone reactor as is depicted by way of example in FIG. 1 and in detail view in a further embodiment in FIG. 2.

The cyclone reactor can, in particular embodiments, comprise a reaction region on which the feed devices for the combustion gas, metal M and the carrier gas can be installed, for example in the form of a rotationally symmetric upper part, a separation region which has, for example, a conical configuration, and a depressurization chamber on which a discharge device for solid and/or liquid reaction products of the combustion of metal M by means of the combustion gas, for example in the form of a star feeder, and also a discharge device for the mixture of offgas and carrier gas which is obtained after mixing of the two gases after combustion of the metal M in the combustion gas can be installed.

Such apparatus components are, for example, usually present in cyclone separators. A cyclone reactor used according to the invention can, however, also have a different structure and optionally also comprise further regions. For example, individual regions (e.g. reaction region, separation region, depressurization chamber) can also be combined in one component of an illustrative cyclone reactor and/or extend over a plurality of components of a cyclone reactor.

An illustrative cyclone reactor is shown in FIG. 1. The cyclone reactor 6 shown in FIG. 1 comprises a reaction region 20a, a separation region 20b, which is located both together with the reaction region 20a in the upper component 6a and also together with the depressurization chamber 20c in the lower component 6b, and a depressurization chamber 20c. A feed device 1 for combustion gas, for example in the form of an optionally heated tube or a hose, and a feed device 2 for metal M, for example in the form of an optionally heated tube or a hose, lead into the cyclone reactor in the upper part, with the two feed devices being combined in the nozzle 3 and then fed together to the reaction region 20c. A nozzle 3 is, for example, suitable when use is made of liquid metal M which can then be atomized by means of the nozzle. However, the metal M can optionally also be atomized in the form of solid particles. Other types of atomization or mixing of metal M and combustion gas are also possible. The carrier gas is fed through the feed device 4 to a region 4′ for gas distribution, from which the carrier gas is then fed through nozzles 5, by means of which a cyclone can be formed, to the separation region 20b. A detail view of such a feed device 4 having a region 4′ for gas distribution and a nozzle 5 is shown by way of example in cross section in FIG. 4, but it is also possible for more nozzles 5 to be present, for example in a suitable spacer ring around the interior wall of the region 4′, in order to generate a suitable cyclone. From the lower component 6b, which comprises the depressurization chamber 20c, solid and/or liquid reaction products are discharged via the discharge device 7 for solid and/or liquid reaction products of the combustion of metal M by means of the combustion gas, while the mixture of offgas and carrier gas is discharged via the discharge device 8 for the mixture of offgas and carrier gas.

In an apparatus according to the invention, an ignition device, for example an electric ignition device or a plasma arc, or an additional ignition burner may be necessary, with this being able to depend on the type and state of the metal M, for example its temperature and/or state of matter, the nature of the combustion gas, for example its pressure and/or temperature, and the arrangement of components in the apparatus, for example the type and nature of the feed devices.

To obtain, by means of the construction, both a high offgas temperature of, for example, more than 200° C., for example also 600° C. or more and in particular embodiments 700° C. or more, and an elevated (e.g. 5 bar or more) or high (20 bar or more) operating pressure, the interior material of the reactor can consist of highly heat-resistant alloys, for example in the extreme case also of the material Haynes 214. Around this material, which is merely intended to withstand the high temperature, it is then possible to arrange thermal insulation which allows sufficiently little heat to pass through, so that a steel wall, which can additionally be air- or water-cooled, takes up the pressure load on the outside. The offgas can then be fed to the further process step having the increased or high operating pressure.

In addition, the reactor, for example a cyclone reactor, can also comprise heating and/or cooling devices which are present on the reaction region, the separation region and/or the depressurization chamber and, however, also on the various feed and/or discharge devices, optionally the burner, and/or optionally the ignition device. In addition, further components such as pumps for generating a pressure or a vacuum, etc., can be present in an apparatus according to the invention.

In embodiments in which the reactor is configured as a cyclone reactor, the cyclone reactor can have a mesh which is configured in such a way that the solid and/or liquid reaction products in the combustion of the metal M by means of the combustion gas can be discharged through the mesh. In addition, however, such a mesh can also be present in other reactors which can be provided in the apparatus of the invention. However, the use of the mesh in the cyclone reactor makes it possible to achieve better separation of the solid and/or liquid reaction products in the combustion of the metal M by means of the combustion gas from the mixture of offgas and carrier gas. Such a mesh is shown by way of example in FIG. 2, according to which the mesh 6′ is located by way of example in the cyclone reactor 6 which is depicted in FIG. 1 in the lower component 6b above the discharge device 7 and below the discharge device 8.

Reliable precipitation of solid and liquid reaction products or a mixture thereof can be ensured by means of the mesh, preferably with a sufficiently large spacing to the reactor wall. In this way, the solid or liquid combustion products which have already been deposited are also no longer swirled up by the cyclone.

The geometry of the feed devices is not subject to any particular restrictions as long as the carrier gas can be mixed with the offgas from the combustion of metal M and combustion gas. A cyclone is preferably formed here, e.g. with the apparatus shown in FIG. 1. However, a cyclone can also be produced by other arrangements of the feed devices relative to one another. Thus, for example, it is not ruled out that the feed device for the carrier gas is also present at the top of the reactor in the vicinity of the feed devices for metal M and combustion material. Correspondingly suitable geometries of the injection can easily be determined in an appropriate way, for example with the aid of flow simulations.

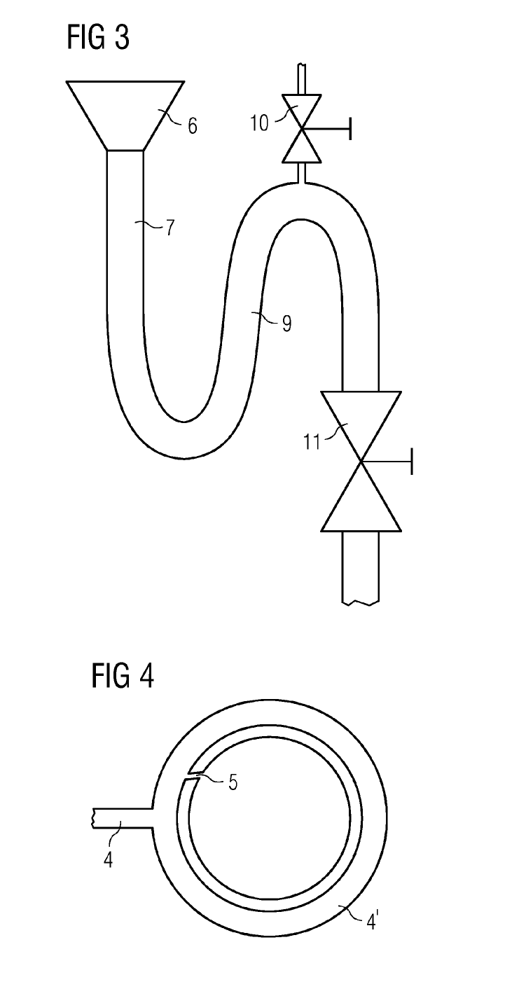

The discharge devices are also not subject to any particular restrictions, with, for example, the discharge device for the mixture of offgas and carrier gas being able to be configured as a tube while the discharge device for the solid and/or liquid reaction products of the combustion of metal M by means of the combustion gas can, for example, be configured as a star feeder or as a tube having a siphon. Here, various valves such as pressure valves and/or further regulators can also be provided. An illustrative discharge device 7 shown in FIG. 3, for example the cyclone reactor 6 shown in FIG. 1, can here comprise a siphon 9, a valve 10 for degassing and a pressure regulator 11, but is not restricted to such a device. A siphon of this type on the discharge device for the solid and/or liquid reaction products of the combustion of metal M by means of the combustion gas, optionally in combination with a prepressure regulator suitable for the respective operating pressure, can, for example, be used in order to make possible an elevated or high operating pressure.

The discharge device for the mixture of offgas and carrier gas can, in particular embodiments, also contain a separation device for the offgas and the carrier gas and/or individual components of the offgas.

In particular embodiments, the discharge device for a mixture of offgas and carrier gas can be connected to the feed device for carrier gas and/or the feed device for combustion gas in such a way that the mixture of offgas and carrier gas is fed at least partly to the reactor as carrier gas and/or to the burner as combustion gas. The proportion of the recirculated gas can here be 10% by volume or more, preferably 50% by volume or more, more preferably 60% by volume or more, even more preferably 70% by volume or more and even more preferably 80% by volume or more, based on the total volume of carrier gas and offgas. In particular embodiments, recirculation of the mixture of offgas and carrier gas can be carried out to an extent of 90% by volume or more, based on the total volume of carrier gas and offgas.

In particular embodiments, an apparatus according to the invention can further comprise at least one boiler and/or at least one heat exchanger which is located in the reactor and/or the discharge device for the mixture of offgas and carrier gas. Thus, for example, one or more heat exchangers and/or boilers, which are not shown, can be provided in the apparatus of FIG. 1, which comprises a cyclone reactor 6, in the reactor 6, in the discharge device 8 and/or in a device which adjoins the discharge device 8. Heat exchange can also take place at the cyclone reactor 6 itself, for example at the exterior walls in the reaction region 20a and/or the separation region 20b, or else optionally in the region of the depressurization chamber 20c.

The offgases can thus be fed as a mixture with carrier gas to a further use, e.g. heating a boiler for steam generation, release of heat in a heat exchanger, etc.

If a suitable heat exchanger by means of which, for example, air having an appropriate pressure is then heated and conveyed as replacement for the offgas into the gas turbine cannot be found, it is possible to use, for example, a boiler. The method using a boiler can, in particular embodiments, be more promising and is also technically simpler since it can be realized at lower temperatures and only superatmospheric pressure.

One or more heat exchangers and/or one or more boilers then enable electric energy to be generated subsequently, for example by use of a steam turbine and a generator. However, it is also possible for the mixture of offgas and carrier gas to be conveyed directly to a turbine in order to thus generate electric power directly. However, this requires very good removal of solids and/or liquid reaction products of the combustion of metal M and combustion gas, as can be provided according to the invention, especially using a mesh in the reactor. The choice of whether a boiler or a heat exchanger is used can, for example, depend on whether solid or liquid reaction products are formed, but can also be determined by plant engineering considerations. In the case of liquid reaction products, e.g. Li₂CO₃, the reactor wall, for example, can function as heat exchanger, while, in the case of formation of solid reaction products, specific heat exchangers can be necessary. When the mixture of offgas and carrier gas is appropriately separated from the solid and/or liquid reaction products, conveying the mixture of offgas and carrier gas directly to a turbine may also be possible, so that heat exchangers and/or boilers in the offgas stream may then also be unnecessary here.

In particular embodiments, an apparatus according to the invention can comprise an offtake device in the discharge device for the mixture of offgas and carrier gas, which offtake device is configured, in the case of recirculation of the mixture of offgas and carrier gas to the feed device for carrier gas and/or the feed device for combustion gas by connection of the discharge device for the mixture of offgas and carrier gas to the feed device for carrier gas and/or the feed device for combustion gas, for taking off part of the mixture of offgas and carrier gas. Such a part can be, for example, more than 1% by volume, preferably 5% by volume and more and more preferably 10% by volume or more, based on the total volume of the mixture of offgas and carrier gas. Furthermore, in particular embodiments, not more than 50% by volume, preferably 40% by volume or less, more preferably 30% by volume or less, particularly preferably 20% by volume or less, based on the total volume of the mixture of offgas and carrier gas, can be taken off from the recirculated mixture of offgas and carrier gas. The gas taken off can then be available, for example, as product of value for further reactions, for example when carbon monoxide is discharged and is subsequently converted in a Fischer-Tropsch process into higher-value hydrocarbons.

The solids discharged can also be converted further into materials of value. Thus, for example, metal nitride produced from a combustion using nitrogen can be converted by hydrolysis using water into ammonia and alkali, with the resulting alkali then also being able to serve as scavenger for carbon dioxide and/or sulfur dioxide.

The above embodiments, configurations and further developments can, if it serves a useful purpose, be combined with one another in any way. Further possible configurations, further developments and implementations of the invention also encompass combinations which have not been explicitly mentioned of features of the invention which have been described above or are described below in the context of the working examples. In particular, a person skilled in the art will also add individual features as improvements or additions to the respective basic form of the present invention.

The invention will now be illustrated below with the aid of illustrative embodiments which do not restrict the invention in any way.

In an illustrative embodiment, the metal M, for example lithium, is used in liquid form, i.e. above the melting point, for lithium 180° C. The liquid metal M, e.g. lithium, can be atomized in a nozzle to form fine particles and then reacts immediately, optionally after ignition to start the reaction, with the respective combustion gas, e.g. air, oxygen, carbon monoxide, carbon dioxide, sulfur dioxide, hydrogen, water vapor, nitrogen oxides NOₓ such as dinitrogen monoxide, or nitrogen. The combustion of the metal M, e.g. lithium, can be carried out in an apparatus shown in FIG. 1, for example using a more than stoichiometric amount of the combustion gas in order not to generate excessively high offgas temperatures. The combustion gas can, however, also be added in a stoichiometric or substoichiometric amount relative to the metal M. After combustion, a carrier gas (e.g. nitrogen, air, carbon monoxide, carbon dioxide or ammonia), which can also correspond to the combustion gas, is added for dilution in order to reduce the temperature and to produce a cyclone for precipitation of the solid or liquid reaction products. The hot offgas stream can then be used for heating a boiler for heat transfer in a heat exchanger or the like.

In a second illustrative embodiment, carbon dioxide can be used as combustion gas and carbon monoxide can be used as carrier gas in the apparatus shown in FIG. 1. As metal, use is made of, for example, lithium, e.g. in liquid form, i.e. above the melting point of 180° C. The liquid lithium can be atomized to form fine particles by means of the nozzle 3 and then reacts immediately with the combustion gas. Electric ignition or an additional ignition burner may be required.

The reaction proceeds according to the following equation:

2Li+2CO₂→Li₂CO₃+CO

The combustion of the lithium occurs in the burner firstly in the nozzle 3 or in the vicinity of the nozzle 3, preferably with the stoichiometrically required amount of carbon dioxide, although a slightly superstoichiometric or substoichiometric ratio (e.g. from 0.95:1 to 1:0.95 for the ratio of CO₂:Li) can also be selected. When a very large deficiency of carbon dioxide is used, it is possible for, for example, lithium carbide to be formed and acetylene can then be obtained therefrom.

In the second step, mixing of the combustion products with the carrier gas carbon monoxide, which is blown through nozzles 5 into the reactor 6, occurs in the middle part of the reactor/furnace 6 in the region 4′. This results in formation of a cyclone which leads to the solid and/or liquid reaction products being swirled onto the reactor wall and predominantly depositing there. An excess of carrier gas is preferably used in order to ensure that the heat generated by the combustion is transported away satisfactorily. The temperature in the reactor 6 can be set appropriately by this means.

For combustion in pure carbon dioxide, the lithium carbonate formed has a melting point of 723° C. If the combustion temperature of the reaction products is kept above at least 723° C. by mixing in of gas through the nozzles 3, 5, liquid reaction products for the combustion can be assumed. The nozzles can in this case be used for cooling in the strongly exothermic reaction so that the plant does not heat up too much, with the lower temperature limit being able to be the melting point of the salts formed, here lithium carbonate. If the cyclone is additionally operated using gases other than carbon dioxide, e.g. air, nitrogen or carbon monoxide or further gases, then lithium oxide (melting point mp 1570° C.) or lithium nitride (mp 813° C.) can also be formed in the reaction products. After deposition of the liquid and solid reaction products, which can be improved by means of a mesh 6′, the mixture of offgas and carrier gas is, for example, conveyed into a boiler and utilized for vaporization of water in order then to drive a steam turbine having a downstream generator or to operate other industrial apparatuses (e.g. heat exchangers). The mixture of offgas and carrier gas which has been cooled down after this process can then be utilized again, for example, as carrier gas for producing the cyclone in the furnace. The residual heat of the offgas is thus utilized after the vaporization process in the boiler and only the stoichiometrically required amount of carbon dioxide for the combustion with Li has to be obtained by offgas purification, e.g. from coal power stations.

Table 1 shows the relationship between offgas temperature and stoichiometric excess for the combustion of lithium in pure carbon dioxide, with the calculation having been carried out using non-temperature-dependent specific heats.

TABLE 1
Operation of the furnace using carbon dioxide
as combustion gas and as carrier gas

| | Excess of combustion gas | Proportion of CO |
|---|---|---|
| Temperature | as factor, based on the | in the offgas |
| in the offgas | mass of combustion gas | [% by weight] |
| 1400° C. | 8.0 | 12.5% |
| 1200° C. | 9.8 | 10.2% |
| 800° C. | 15.8 | 6.3% |

Recirculation of the offgas which has been cooled by means of the subsequent process step allows carbon monoxide to accumulate in the offgas. It is in this case possible, in particular embodiments, to take off a proportion from the offgas and thus obtain a gas mixture of carbon monoxide and carbon dioxide which has a significantly higher proportion of carbon dioxide than is indicated in table 1. The carbon monoxide can be cleaned of the carbon dioxide by means of a subsequent gas separation and the carbon dioxide can be used further in the circuit or in the burner.

Recirculation of the product gas CO enables the combustion temperature in the furnace to be reduced. In stoichiometric combustion, gas temperatures of over 3000 K can be attained and these would lead to materials problems. Lowering of the combustion temperature would also be possible by means of an excess of CO₂. However, this would have to be about 16 times higher than the stoichiometric amount, so that the product gas CO would be present in greatly diluted form in the excess of CO₂ (concentration only about 6% by volume). It is therefore useful, as per particular embodiments, to recirculate part of the product gas CO to the burner and use it as thermal ballast for lowering the temperature. Here, a particular reaction temperature is preferably set by recirculation of a constant amount of the mixture of offgas and carrier gas as carrier gas. In this case, there is no formation of a CO/CO₂ mixture which has to be separated in a complicated manner. The product gas consists mainly of CO and only small contaminating proportions of CO₂. In the steady state, the major part of the CO is carried away in the circuit and just that amount of CO which is reproduced by the reaction of CO₂ and Li is discharged from the circuit. For example, such a circuit can be obtained when CO is used as carrier gas in a ratio of 90% by volume or more, based on the mixture of offgas and carrier gas. A suitable amount of carbon dioxide can thus be introduced continually into the combustion process, while a corresponding amount of carbon monoxide can be taken off continually as product of value from the circuit.

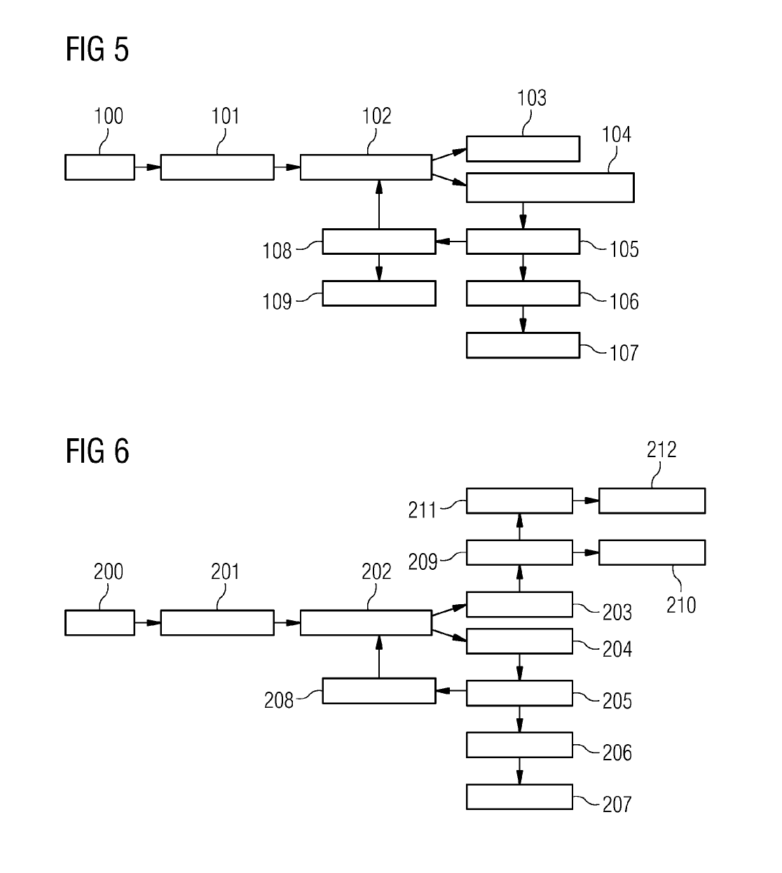

A reaction procedure of this type is also shown by way of example in FIG. 5. Carbon dioxide is separated off from an offgas 100, for example from a combustion power station such as a coal power station, in a CO₂ removal 101 and then burnt with lithium in step 102, with CO being used as carrier gas. Li₂CO₃ 103 is formed, and a mixture of offgas and carrier gas comprising CO₂ and CO can, optionally after a separation 104, be conveyed via a boiler 105 by means of which a steam turbine 106 and thus a generator 107 are operated. Offgas is recirculated 108 as carrier gas, with CO being able to be discharged in step 109.

In a third illustrative embodiment, nitrogen can be used as combustion gas and as carrier gas in the apparatus shown in FIG. 1. As metal, use is made of, for example, lithium, e.g. in liquid form, i.e. above the melting point of 180° C. The liquid lithium can be atomized by means of the nozzle 3 to form fine particles and then reacts immediately with the combustion gas. Electric ignition or an additional ignition burner may be required.

The combustion of lithium occurs in the burner firstly in the nozzle 3 or in the vicinity of the nozzle 3 with the stoichiometrically required amount of nitrogen, with a slightly superstoichiometric or substoichiometric ratio (e.g. from 0.95:1 to 1:0.95 for the ratio of N₂:Li) also being able to be selected.

The reaction here is as follows:

6Li+N₂→2Li₃N

In the second step, mixing of the combustion products with the carrier gas, for example nitrogen, which is blown through the nozzles 5 into the reactor 6, occurs in the middle part of the reactor 6. This results in formation of a cyclone which leads to the solid and liquid reaction products being swirled onto the reactor wall and predominantly depositing there. For combustion in pure nitrogen, the lithium nitride formed has a melting point of 813° C. If the combustion temperature of the reaction products is kept above at least 813° C. by means of mixing in of carrier gas and/or combustion gas through the nozzles 3, 5, liquid reaction products can be assumed for the combustion. The nozzles can here be used for cooling in the strongly exothermic reaction so that the plant does not heat up too much, with the lower temperature limit being able to be the melting point of the salts formed, here lithium nitride. If the cyclone is operated by means of gases other than nitrogen, e.g. air or carbon dioxide or further gases, lithium oxide (mp 1570° C.) or lithium carbonate (mp 723° C.) can also be formed in the reaction products. After deposition of the liquid and/or solid reaction products, which can be improved by means of a mesh 6′, the offgas is, for example, introduced into a boiler and utilized for the vaporization of water in order then to drive a turbine with downstream generator or to operate other industrial apparatuses (e.g. heat exchangers). The offgas which has been cooled after this process can, for example, be utilized again for producing the cyclone in the reactor 6. The residual heat of the offgas is thus utilized after the vaporization process in the boiler and only the stoichiometrically required amount of nitrogen for the combustion has to be obtained, for example by fractionation of air.

Table 2 shows the relationship between offgas temperature and stoichiometric excess for the combustion of lithium in pure nitrogen, with the calculation having been carried out using non-temperature-dependent specific heats.

TABLE 2
Operation of the furnace using nitrogen
as combustion gas and as carrier gas

| | Excess of combustion gas |
|---|---|
| Temperature | as factor, based on the |
| in the offgas | mass of combustion gas |
| 1400° C. | 8.5 |
| 1200° C. | 10.2 |
| 800° C. | 16.1 |

A reaction procedure of this type is also shown by way of example in FIG. 6. Nitrogen is separated off from the air 200 in an air fractionation 201 and then burnt with lithium in step 202, using nitrogen, for example likewise from the air fractionation 201, as carrier gas. Li₂N₃ 203 is formed, and the mixture of offgas and carrier gas comprising N₂ 204 can be conveyed via a boiler 205 by means of which a steam turbine 206 and thus a generator 207 are operated. Offgas is recirculated 208 as carrier gas. Ammonia 210 can be obtained from the lithium nitride 203 by hydrolysis 209, forming LiOH 211 which can be reacted with carbon dioxide to form lithium carbonate 212.

In a fourth illustrative embodiment, it can also be possible, e.g. when using air as combustion gas, to use two reactors, e.g. two cyclone reactors, in series, with metal oxide, e.g. Li₂O, being able to be produced in the first cyclone reactor by means of the metal M, e.g. lithium, and the oxygen from the air, and the offgas containing predominantly nitrogen, and this offgas then being able to react as combustion gas with metal M, e.g. Li, in a second cyclone reactor to form metal nitride, e.g. Li₃N. Here, for example, nitrogen which can also be obtained from the first offgas can function as carrier gas, or the first offgas itself can function as carrier gas when, for example, it is circulated.

The construction of the apparatus of the invention and the use of the process of the invention make it possible, in a combustion of metal M by means of a combustion gas, to separate the solid or liquid reaction products or a mixture thereof from the offgases and thus pass them to a use in, for example, a boiler and/or a heat exchanger. Furthermore, the apparatus can be operated at an elevated operating pressure and the combustion process and deposition/separation process can thus be matched to the respective conditions of the subsequent step. The possibility of differentiation of combustion gas and carrier gas for establishing the cyclone makes it possible to recirculate offgases after the release of heat. Recirculation is readily possible by means of this construction. Gas mixtures are also possible as combustion gas and carrier gas. Energy and material can be saved by recirculation of the offgas after the process step or steps.

What is claimed is:

1. A process for separating offgas from solid and/or liquid reaction products in the combustion of a metal M selected from among alkali metals, alkaline earth metals, Al and Zn and mixtures thereof by a combustion gas, the method comprising:
burning the combustion gas with the metal M in a reaction step to form offgas and further solid and/or liquid reaction products; and
separating the offgas from the solid and/or liquid reaction products, and
additionally adding a carrier gas in the separation step and discharging the carrier gas as a mixture with the offgas.

2. The process of claim 1, wherein the mixture of offgas and carrier gas is at least partly fed as carrier gas back to the separation step and/or fed as combustion gas to the combustion step.

3. The process of claim 1, wherein the separation step is performed in a cyclone reactor.

4. The process of claim 3, wherein the cyclone reactor additionally comprises a mesh through which the solid and/or liquid reaction products in the combustion of the metal M can be discharged via the combustion gas.

5. The process of claim 1, wherein the combustion gas comprises air, oxygen, carbon monoxide, carbon dioxide, sulfur dioxide, hydrogen, water vapor, nitrogen oxides NOₓ, or mixtures of one or more thereof.

6. The process of claim 1, wherein the mixture of offgas and carrier gas is used for heating a boiler or for transferring heat in a heat exchanger.

7. The process of claim 1, wherein the mixture of the carrier gas and the offgas after the combustion is under elevated pressure.

8. The process of claim 1, wherein at least part of the offgas corresponds to the carrier gas.

9. An apparatus for the separation of offgas in the combustion of a metal M selected from among alkali metals, alkaline earth metals, Al and Zn and mixtures thereof by a combustion gas, the apparatus comprising:
a burner configured to burn the metal M by means of the combustion gas;
a first feed device configured to feed combustion gas to the burner;
a second feed device configured to feed metal M to the burner;
a reactor connected to the burner;
a third feed device configured to feed carrier gas to the reactor;
a first discharge device configured to discharge a mixture of the offgas of the combustion of metal M via the combustion gas and the carrier gas; and
a second discharge device configured to discharge solid and/or liquid reaction products of the combustion of metal M via the combustion gas.

10. The apparatus of claim 9, wherein the first discharge device is connected to at least one of the feed device or the second feed device such that the mixture of offgas and carrier gas is fed at least partly to the reactor as carrier gas and/or to the burner as combustion gas.

11. The apparatus of claim 9, wherein the reactor is a cyclone reactor.

12. The apparatus of claim 11, wherein the cyclone reactor comprises a mesh through which the solid and/or liquid reaction products in the combustion of the metal M are discharged.

13. The apparatus of claim 9, further comprising at least one boiler and/or at least one heat exchanger located in the reactor and/or the discharge device for the mixture of offgas and carrier gas.

14. The apparatus of claim 9, further comprising an offtake device in the first discharge device, the offtake device being configured, in the case of recirculation of the mixture of offgas and carrier gas to the feed device for carrier gas and/or the feed device for combustion gas by connection of the discharge device for the mixture of offgas and carrier gas to the feed device for carrier gas and/or the feed device for combustion gas, for taking off part of the mixture of offgas and carrier gas.
